(19) United States
(12) Patent Application Publication
(10) Pub. No.: US 2010/0080870 A1
(43) Pub. Date: Apr. 1, 2010

(54) PROCESS FOR PREPARING HYPOALLERGENIC AND/OR NON-ALLERGENIC PEANUT BUTTER AND ASSOCIATED PRODUCTS

(76) Inventors: Mohamed Ahmedna, Greensboro, NC (US); Jianmei Yu, Greensboro, NC (US); Ipek Goktepe, Greensboro, NC (US)

Correspondence Address: SMITH MOORE LEATHERWOOD LLP, P.O. BOX 21927, GREENSBORO, NC, 27420, US

(21) Appl. No.: 12/631,325

(22) Filed: Dec. 4, 2009

Related U.S. Application Data
(63) Continuation-in-part of application No. 11/758,823, filed on Jun. 6, 2007.

(51) Int. Cl. A23J 3/14

(52) U.S. Cl. 426/63

(57) ABSTRACT

The present invention relates to the use of a solution containing at least one endopeptidase to substantially reduce or completely eliminate allergenic proteins contained in the peanut (Arachis hypogea). In particular, the direct application of a solution containing at least one endopeptidase to either raw, blanched, or roasted peanuts or peanut products such as peanut butter or derivates, has been shown to substantially reduce or completely eliminate the activity of allergenic proteins. The treated peanuts and peanut products showed no degradation in quality or sensory acceptability, and have the flavor and aroma of natural whole peanuts and untreated peanut products. Hypoallergenic or non-allergenic peanuts or peanut products produced in accordance with the present invention may be used as ingredients in various food products and other edible materials.

This application is a continuation-in-part of U.S. patent application Ser. No. 11/758,823, filed on Jun. 6, 2007, the disclosure of which is expressly incorporated herein by reference.

### FIELD OF THE INVENTION

The present invention relates to a simple and inexpensive method for substantially reducing, or completely eliminating, the allergenicity of the peanut (Arachis hypogea) by directly applying a hypoallergenically-effective amount of a solution comprising at least one endopeptidase to raw, blanched, or roasted peanuts, or peanut products or derivatives (including, but not limited to, peanut butter, peanut kernels, peanut skins, peanut protein isolate, peanut flour, or peanut milk) produced from raw, blanched, or roasted peanuts. The endopeptidase-treated peanuts have the flavor and aroma of natural whole peanuts, but the allergens which cause allergic reactions in the majority of those people who suffer from peanut allergies, have been either substantially (e.g., greater than about 30%) reduced or completely (100%) eliminated. Similarly, endopeptidase-treated peanut butter has the flavor and aroma expected of both home-made and commercially available peanut butter, but the allergens which cause allergic reactions in the majority of those people who suffer from peanut allergies have been either substantially (e.g, greater than about 30%) reduced or completely (100%) eliminated.

### BACKGROUND OF THE INVENTION

Many persons suffer from various allergies, several of which are caused by ingesting foods containing allergens, which are usually proteins. Although the biochemistry of allergic reactions is not precisely understood, it is believed that proteinaceous allergens cause, upon ingestion or other contact with the human body, a specific reagin to be formed in the blood. The ability to produce reagins, chemically identified as IgE, in response to a given allergen is thought to be an inherited characteristic that differentiates an allergic person from a non-allergic person. The specificity of the allergen-reagin reaction is similar to the antigen-antibody reaction.

It has been estimated that approximately 8% of children and 2% of adults have allergic reactions to food (Weangsripanaval et al., Journal of Nutrition: 2005, 1738-1744). Many common foods contain various allergens, and food allergy is common in both adults and children. Foods which are generally regarded as being particularly allergenic include chocolate, nuts, milk and milk byproducts, wheat, eggs, corn, pork, soybeans, tomatoes, oranges, crustaceans, rice, seafood, fish spices, condiments, wine, and other products of fermentation. Symptoms of food allergy range from mild to severe, and can include allergic skin eruptions, respiratory tract allergy (allergic rhinitis and asthma), gastrointestinal reactions, shock-like reactions, vascular collapse, and allergic anaphylaxis.

Peanuts are a very frequently consumed and popular food product. However, allergists have long-recognized that peanuts contain allergens. In fact, the peanut allergens are among the most severe common allergens, and have been referred to as “super allergens” because they account for at least 70% of severe anaphylactic reactions. Many studies have been done to characterize the special proteins responsible for peanut allergies. To date, eleven proteins, classified Ara h1 to Ara h11, have been recognized (Wen et al., Comprehensive Review in Food Science and Food Safety. 6: 47-58, 2007; Mills et al., Trends in Food Science & Technology 14: 145-46, 2003; the Allergen Nomenclature Sub-committee of the International Union of Immunological Societies, 2009, http://www.allergen.org/Allergen.aspx). Among these allergens, Ara h1 (63.5 KDa) and Ara h2 (16-17 KDa) are major peanut proteins that account for 12-16% and 5.9-9.3%, respectively, of the total amount of peanut protein. The individual content of these allergens in peanuts of different varieties is similar regardless of where such peanuts were grown (Koppelman et al., Allergy, 56(2): 132-137, 2001). Furthermore, more than 95% of peanut allergic individuals had specific IgE to Ara h1 and Ara h2 (Scurlock and Burks, Ann Allergy Asthma Immunol., 93(5): S12-8, 2004). Ara h3 through Ara h8 are considered minor peanut allergens due to their lower sensitizing rate to peanut allergic individuals (Wen et al., 2007). The allergenic potency of other peanut allergens (Ara h9, Ara h10 and Ara h11) was not yet been reported.

The common feature of these allergens is that they show unusually high stability to denaturation and proteolysis, a property that may contribute to their high allergenicity. The two major peanut allergens are seed storage proteins known as Ara h1, a member of the vicilin family, and Ara h2, a conglutin-homologue protein. These two allergens are recognized by serum IgE from >90% of peanut allergic patients (Maleki et al., Journal of Immunology: 2000, 164, 5844-5849).

Although peanuts are most often consumed raw, blanched (boiled for a short period of time), or roasted, or in the form of peanut butter, peanut milk, or peanut flour, and may thus be easily avoided by sensitive individuals, the myriad of hidden ways in which peanuts are used make it difficult to avoid all contact. For example, peanut oil, peanut butter, and peanut flour are very frequently used as ingredients in popular food products such as candy, ethnic foods, hydrogenated oils, margarine, vegetable burgers, spaghetti sauce, and chili. In addition, food products that normally do not contain peanuts or peanut products are frequently cross-contaminated with peanuts because the same machinery is often used to prepare several different food products. Contamination may also be picked up from storage bins.

The food industry has voluntarily adopted stringent regulations for the clean-up and labeling of peanut allergen-containing foods. Significant efforts and costs are expended each year in the recall of foods suspected to contain traces of peanut allergens. Accordingly, there exists a great need for a hypoallergenic peanut, both to improve food safety and to permit allergic individuals to enjoy this common and nutritious food.

Accordingly, there is a need for a hypoallergenic food containing peanuts or peanut products, particularly one which has the taste and aroma of fresh peanuts.

Advantageously, the inventors have discovered that direct treatment of peanuts or peanut derivatives with a solution containing at least one endopeptidase in the manner described below can either substantially reduce (e.g., greater than about 30%) or completely eliminate allergenic activity, as indicated by immunoassays.

### SUMMARY OF THE INVENTION

The present invention provides a clean, simple, and inexpensive method for substantially (e.g., greater than about 30%) reducing or completely (100%) eliminating the allergenic activities of allergenic proteins by direct application of a hypoallergenically-effective amount of a solution containing at least one endopeptidase to either raw, blanched, or roasted peanuts, or peanut products or derivatives (including, but not limited to peanut butter, peanut kernels, peanut skins, peanut protein isolate, peanut flour, or peanut milk) produced from raw, blanched, or roasted peanuts. In an aspect of an embodiment of the present invention, the hypoallergenically-effective amount of the endopeptidase in solution is at least about 0.001% (w/w). In another aspect of an embodiment, a new and useful hypoallergenic food product is produced to contain peanuts or peanut products, including, but not limited to, peanut butter, peanut kernels, peanut skins, peanut protein isolate, peanut flour, peanut milk, and peanut kernel-based snacks. In another aspect of an embodiment of the present invention, the substantial (e.g., greater than about 30%) reduction or complete (100%) elimination of allergenic activities is achieved in peanuts without destroying taste, aroma, and flavor. It is a further aspect of an embodiment of this invention to substantially reduce or completely eliminate allergenic activities in peanuts and peanut products quickly, simply, safely, and at relatively low cost.

### BRIEF DESCRIPTION OF THE FIGURES

The present invention is better understood by a reading of the Detailed Description of the Invention along with a review of the drawings, in which:

FIG. 1: Graph of the effect of enzyme treatment of home-made peanut butter with α-chymotrypsin at room temperature (22° C.) on amount of Ara h1 and Ara h2 present.

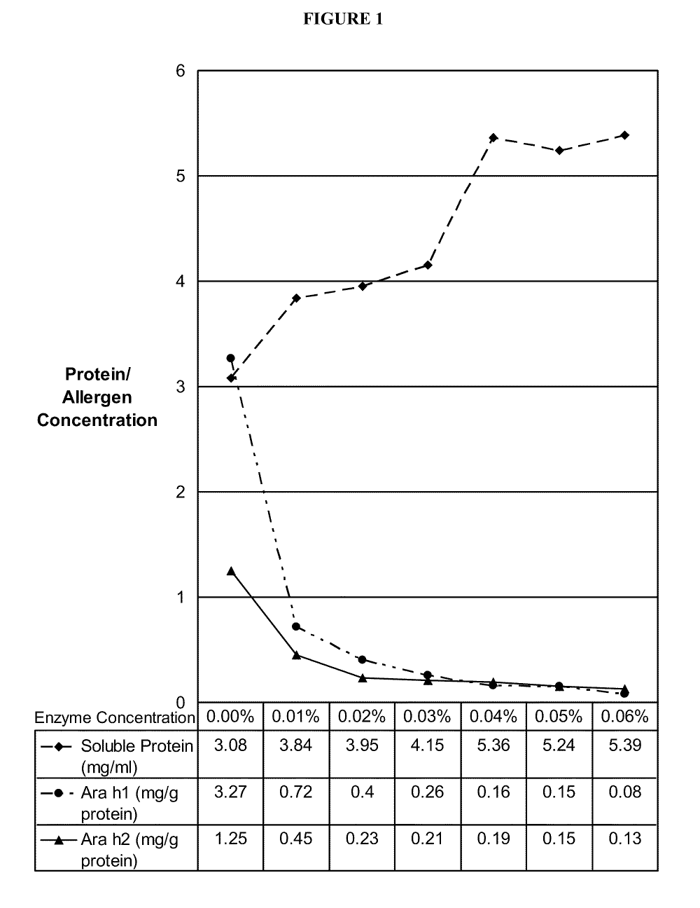

FIG. 2: Graph of the effect of enzyme treatment of home-made peanut butter with trypsin at room temperature (22° C.) on amount of Ara h1 and Ara h2 present.

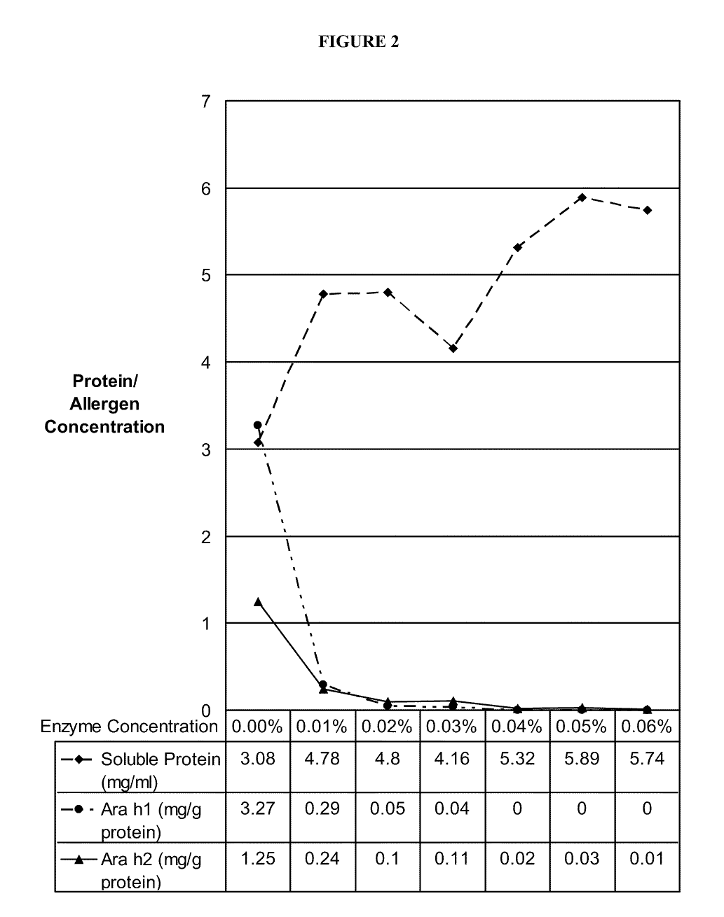

FIG. 3: Graph of the effect of enzyme treatment of home-made peanut butter with α-chymotrypsin and trypsin (1:1 by weight) at room temperature (22° C.) on amount of Ara h1 and Ara h2 present.

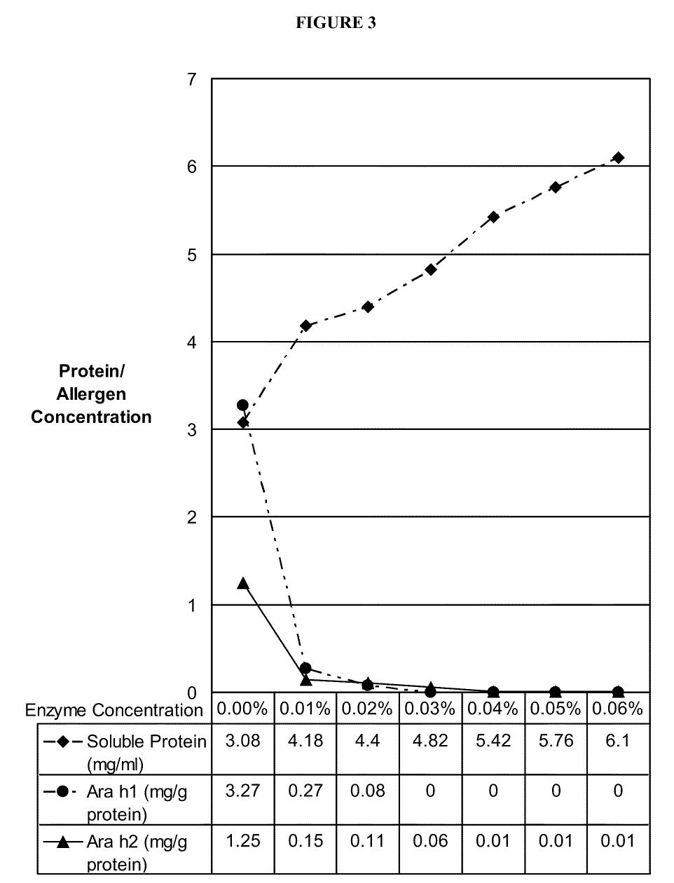

FIG. 4: Graph of the effect of enzyme treatment on Ara h1 in commercially available peanut butter samples (enzyme (trypsin and α-chymotrypsin at 1:1 in weight) to peanut butter ratio=0.06% w/w) at 22° C. for 24 hours followed by cold storage at 4° C. for one week.

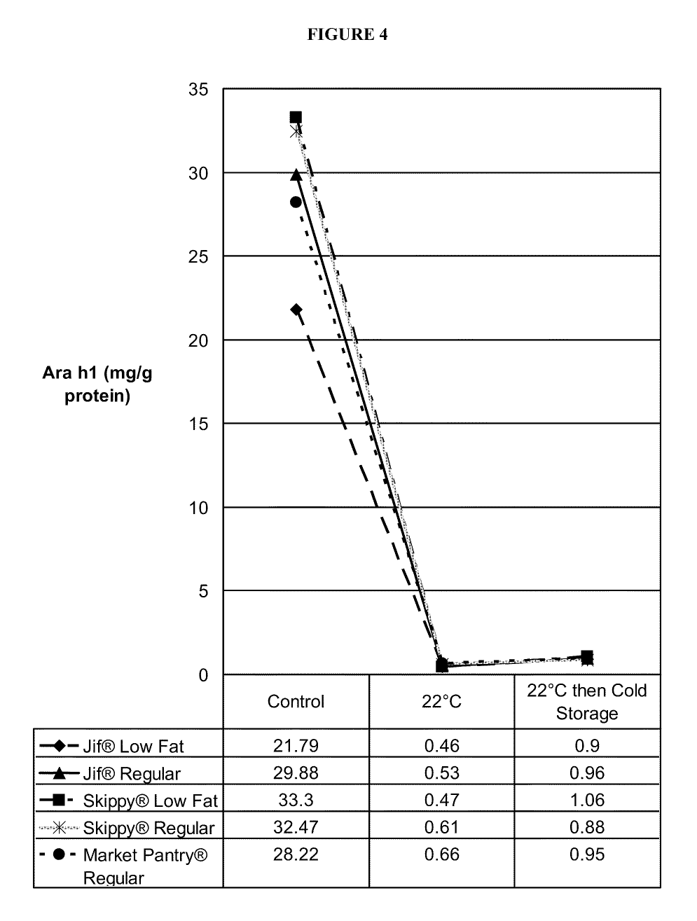

FIG. 5: Graph of the effect of enzyme treatment on Ara h2 in commercially available peanut butter samples (enzyme (trypsin and α-chymotrypsin at 1:1 by weight) to peanut butter ratio=0.06% w/w) at 22° C. for 24 hours followed by cold storage at 4° C. for one week.

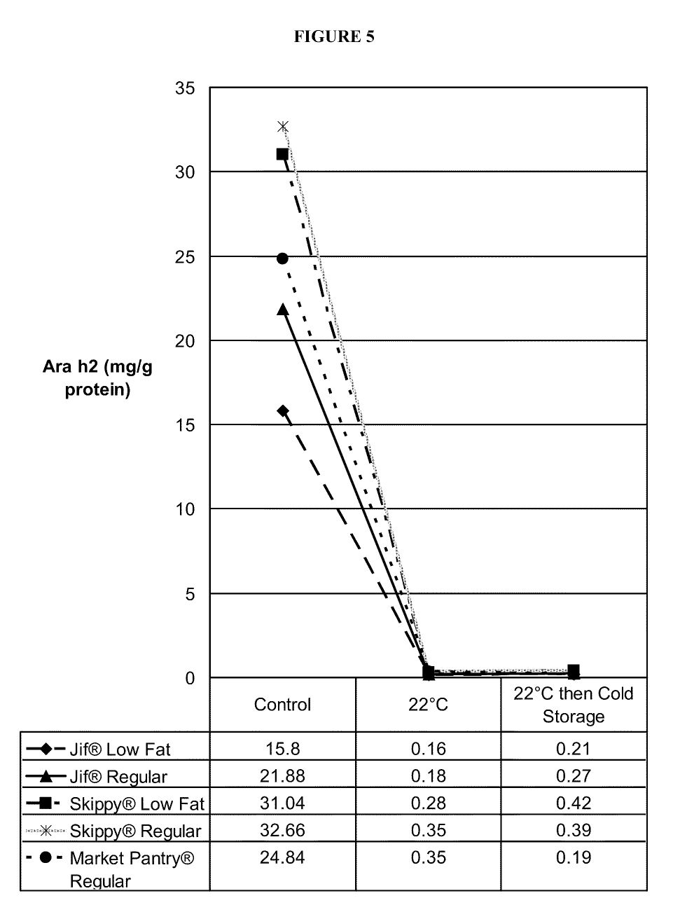

FIG. 6: Graph of the comparison of the effect of enzyme treatment on Ara h1 and Ara h2 in commercially available peanut butter samples (enzyme (trypsin and α-chymotrypsin at 1:1 by weight) to peanut butter ratio=0.06% w/w) at 22° C. for 24 hours followed by cold storage at 4° C. for one week.

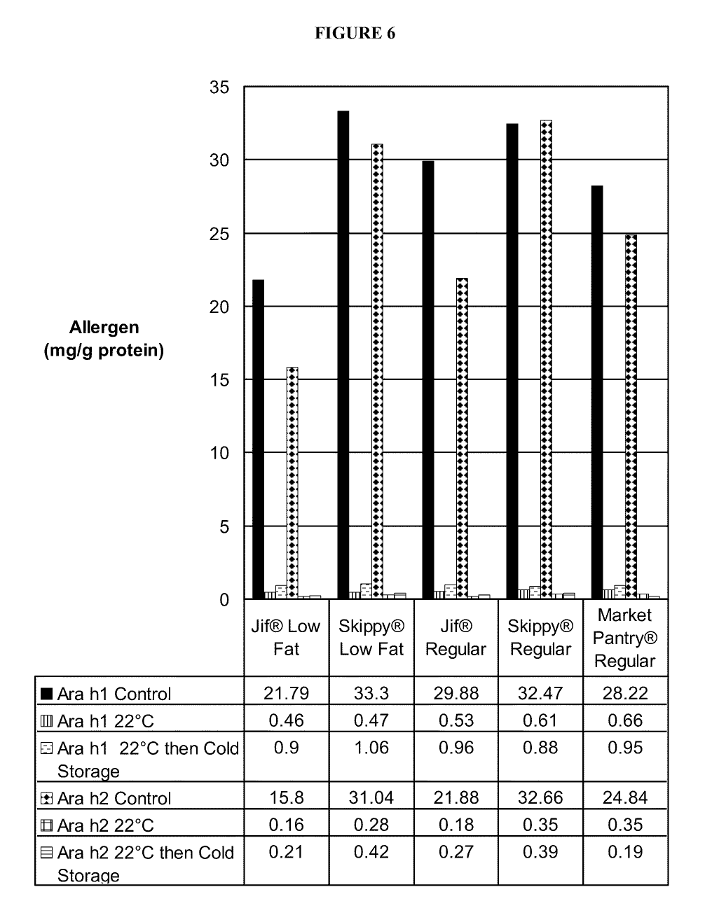

FIG. 7: Graph of the effect of enzyme treatment on Ara h1 in commercially available peanut butter samples (enzyme (trypsin and α-chymotrypsin at 1:1 in weight) to peanut butter ratio=0.06% w/w), at 37° C. for 2 hours followed by cold storage at 4° C. for one week.

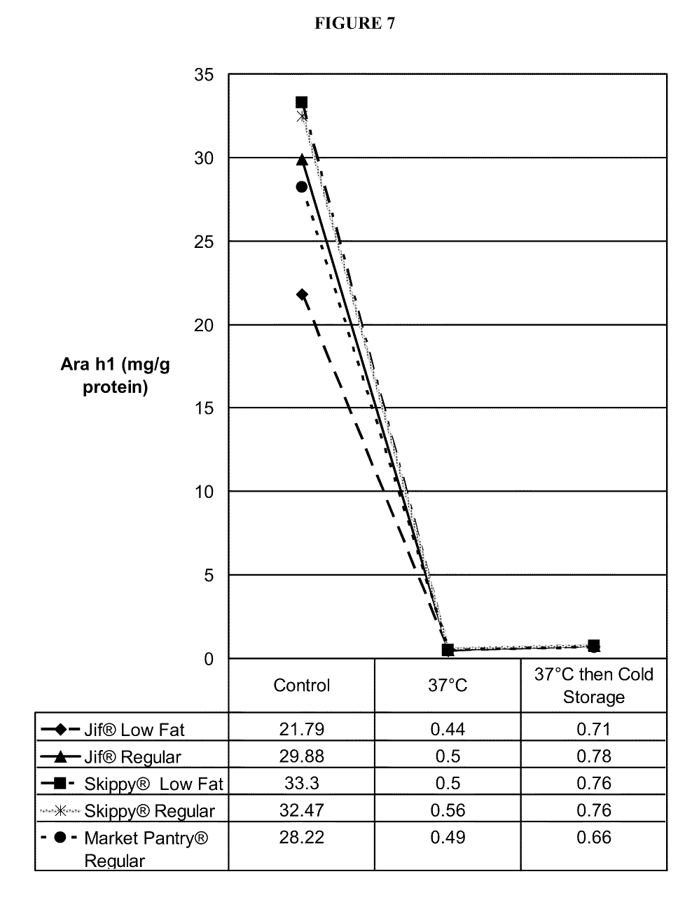

FIG. 8: Graph of the effect of enzyme treatment on Ara h2 in commercially available peanut butter samples (enzyme (trypsin and α-chymotrypsin at 1:1 by weight) to peanut butter ratio=0.06% w/w), at 37° C. for 2 hours followed by cold storage at 4° C. for one week.

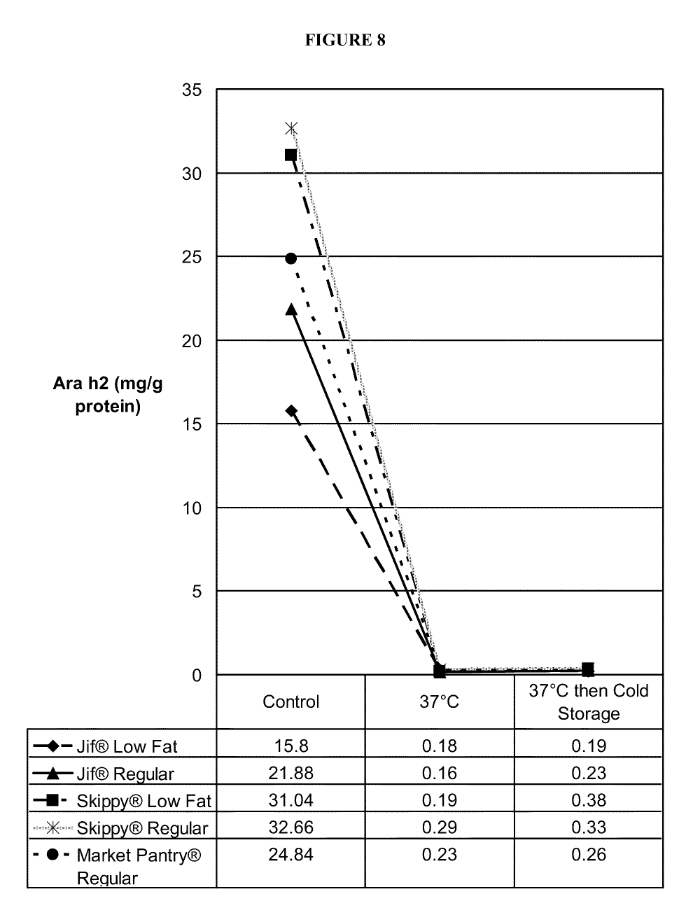

FIG. 9: Graph of the comparison of the effect of enzyme treatment on Ara h1 and Ara h2 in commercially available peanut butter samples (enzyme (trypsin and α-chymotrypsin at 1:1 by weight) to peanut butter ratio=0.06% w/w) at 37° C. for 2 hours followed by cold storage at 4° C. for one week.

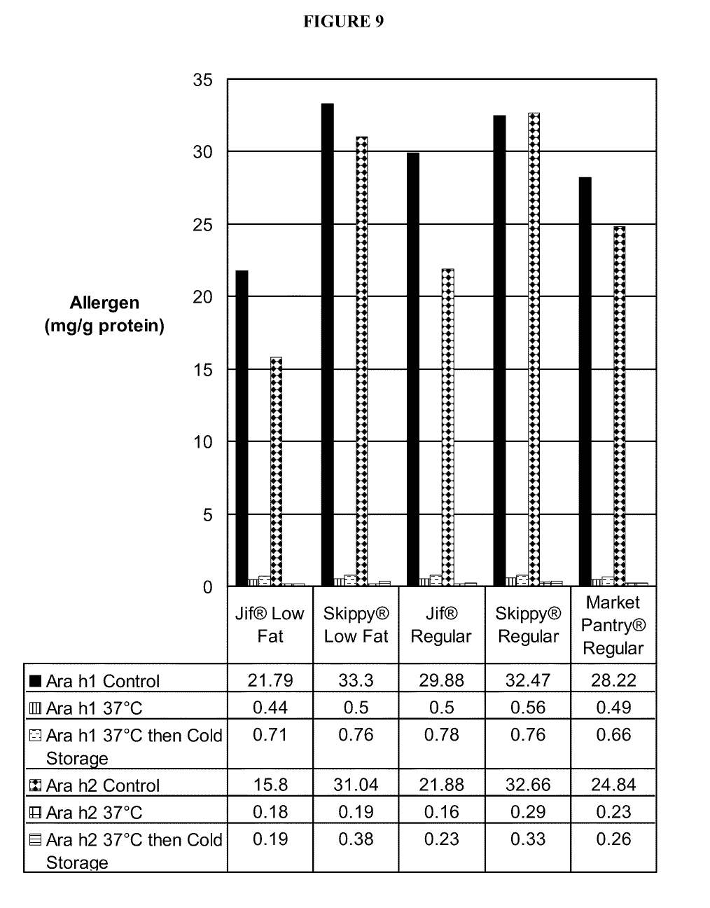

FIG. 10 is the SDS-PAGE of peanut protein extracts from enzyme treated peanut kernels.

FIG. 11 is the SDS-PAGE of peanut protein extracts from enzyme treated and untreated peanut kernels and enzyme treated and untreated home-made peanut butter.

### DETAILED DESCRIPTION OF THE INVENTION

The following definitions are provided in order to aid those skilled in the art in understanding the detailed description of the present invention. Some words and phrases may also be defined in other sections of the specification. No limitation should be placed on the definitions presented for the terms below, where other meanings are evidenced elsewhere in the specification in addition to those specified below.

For purposes of the present invention, the term “allergen” refers to a biological or chemical substance that induces an allergic reaction or response. An allergic reaction can be an immunoglobin (Ig) E-mediated response. The term “IgE” (Immunoglobin E) refers to a specific class of immunoglobin secreted by B cells. IgE binds to specific receptors on Mast cells. Interaction of an allergen with Mast cell-bound IgE may trigger allergic symptoms.

For purposes of the present invention, the term “hypoallergenic” means a decreased tendency to cause an allergic reaction through the substantial (e.g., greater than about 30%) reduction or complete (100%) elimination of activity of allergenic proteins.

For purposes of the present invention, the term “peanut” means the edible portion of a peanut, whether raw, blanched (boiled for a short period of time), or roasted, or in kernel, butter, milk, protein isolate, or flour form.

For the purposes of the present invention, the term “serine endopeptidase” (or serine protease) means any proteolytic enzyme that is characterized by the presence of a serine residue in the active site of the enzyme.

It has been discovered that the direct treatment of either raw, blanched, or roasted peanuts, or peanut products or derivates (including, but not limited to peanut butter, peanut kernels, peanut skins, peanut protein isolate, peanut flour, or peanut milk) produced from raw, blanched, or roasted peanuts, with a solution containing at least about 0.001% (w/w) of at least one endopeptidase substantially reduces or completely eliminates the activity of peanut allergens. Examples of suitable endopeptidases that may be used in accordance with an aspect of the present invention include, but are not limited to, pepsin, trypsin, and α-chymotrypsin, although it is envisioned that any endopeptidase that hydrolyzes proteins in a similar manner can be utilized in the methods disclosed and claimed in the present invention. In one aspect of an embodiment of the present invention the endopeptidase is a serine endopeptidase. The endopeptidase may also be used alone or in combination with another endopeptidase, or with one or more proteolytic or non-proteolytic enzymes, including, but not limited to esterase, esterase lipase, α-galactoside, α-glucosidase, and α-manosidase. In one aspect of an embodiment of the present invention the endopeptidase solution contains from about 0.001 to about 0.5% pepsin. In another aspect of an embodiment, the endopeptidase solution contains from about 0.001% to about 0.5% trypsin. In a further aspect of an embodiment the endopeptidase solution contains from about 0.001% to about 0.5% α-chymotrypsin. Depending on the concentration of endopeptidase used in the solution, and the particular endopeptidase used, peanut allergens can be substantially reduced or completely inactivated after as little as about 15 minutes (0.25 hrs) of treatment.

Other than in the operating examples, or where otherwise indicated, all numbers below expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The hypoallergenic peanuts according to an aspect of an embodiment of the present invention are prepared by treating peanuts, which may be raw, roasted, or blanched, or whole, or in the form of a peanut product or derivative (including, but not limited to, peanut butter, peanut kernels, peanut skins, peanut protein isolate, peanut flour, or peanut milk), with a solution containing at least about 0.001% (w/w) of at least one endopeptidase. The peanuts may be either raw (unroasted), blanched, or roasted, but a greater reduction in the concentration of allergenic proteins has been observed when the peanuts are roasted. In addition, prior to enzyme treatment, the raw, blanched, or roasted peanuts may be heat-treated. In one aspect of an embodiment, both raw and roasted peanuts are heat-treated by being blanched in boiling water for at least five minutes, but any other heat-treatment methods sufficient to inactivate microorganisms and loosen the kernel structure for enzyme distribution may be utilized. Data indicates that prior blanching of roasted peanuts enhances the effectiveness of the endopeptidase enzyme in inactivating peanut allergens.

Following heat-treatment, the peanut kernels may be left in kernel form or ground into peanut flour.

A solution containing at least about 0.001% (w/w) of at least one endopeptidase is then added to the peanut butter, peanut kernels, peanut skins, peanut protein isolate, peanut flour, or peanut milk. These endopeptidase enzymes may be bacterial, fungal, animal, plant, or recombinant in origin. Furthermore, these enzymes, either alone or in combination with other proteolytic or endopeptidase enzymes, may be added to the peanuts or peanut derivatives in either a continuous or a batch process. In one aspect of an embodiment of the present invention, a solution containing a single endopeptidase in which the concentration of the endopeptidase is at least about 0.001% (w/w) is utilized. Generally, however, the use of an endopeptidase solution in which the concentration of endopeptidase is greater than about 0.1% (w/w) yields a higher reduction in the levels of or complete elimination of peanut allergens, regardless of time of exposure.

In one aspect of one embodiment, trypsin, alone, at a pH in the range from about 5 to 11, and at a concentration in the range from about 0.001% to about 0.5% is utilized to treat peanut kernels. In another aspect of an embodiment, the trypsin is buffered to a pH of 8 and used at a concentration in the range of between about 0.1% and about 0.2%. In another aspect of an embodiment of the present invention, pepsin, alone, at a pH in the range of about 1 to 3 and at a concentration in the range from about 0.001% to about 0.5% is utilized. In a further aspect of an embodiment, the pepsin is buffered to a pH of 2 and used at a concentration in the range of between about 0.1% and about 0.2%. In yet another aspect of an embodiment of the present invention, α-chymotrypsin, alone, is used, at a pH in the range from about 5 to 11 and at a concentration in the range of between about 0.001% to about 0.5%. In a further aspect of an embodiment, the α-chymotrypsin is buffered to a pH of 8 and used at a concentration between about 0.1% and about 0.2%.

In one aspect of one embodiment of the present invention, trypsin, alone, at a pH in the range of about 5 to 11, and at a concentration in the range of between about 0.01% and about 0.06% is utilized to treat peanut butter. In another aspect of an embodiment of the present invention, α-chymotrypsin, alone, at a pH in the range of about 5 to 11, and at a concentration from about 0.01% to about 0.06% is utilized to treat peanut butter. In yet another aspect of an embodiment of the present invention, trypsin and α-chymotrypsin, in conjunction, at a pH in the range of about 5 to 11, and at a combined concentration from about 0.01% to about 0.06% is utilized to treat peanut butter.

Following application of the enzyme solution, the peanuts or peanut products or derivates are incubated at a temperature sufficient to allow enzyme activity to take place and for a period of time sufficient to allow the enzyme to inactivate the allergens. In aspect of one embodiment of the present invention, the enzyme-treated peanut kernels are incubated at a temperature in the range from between about 20° C. to about 50° C. for about 0.25 hours to about 8 hours. In a further aspect of an embodiment, the treated peanut kernels or flour are kept at a temperature of about 37° C. In one aspect of one embodiment of the current invention, the enzyme-treated peanut butter is incubated at a temperature in the range of about 20° C. to about 50° C. for about 2 hours to about 24 hours. In a further aspect of an embodiment, the enzyme-treated peanut butter is kept at a temperature of about 4° C. for about 1 week to about 2 weeks following incubation at a temperature in the range of about 20° C. to about 50° C. for about 2 hours to about 24 hours.

In one embodiment, the peanuts are separated from the enzyme solution and then treated to inactivate any residual enzyme activity following enzyme treatment. Any method of inactivating enzymes may be utilized, but in one aspect of an embodiment the peanuts are dried at a temperature greater than about 60° C. Methods of drying include, but are not limited to, regular oven drying, vacuum oven drying, drum drying, freeze drying, spray drying, or sun drying. In one aspect of an embodiment of the present invention the peanuts are removed from the enzyme solution and dried in a preheated vacuum oven at a temperature of about 65-70° C. overnight.

In another embodiment, the peanuts are not separated from the enzyme solution following enzyme treatment. The enzymes may be inactivated by any known method.

Measurements of concentrations of the two major allergenic proteins, Ara h1 and Ara h2, were used to indicate the reduction in activity of all peanut allergens.

It has been observed that the enzyme treatment has no significant effect on either the taste or aroma of the hypoallergenic peanuts produced in accordance with the present invention. Thus, the hypoallergenic peanuts according to an aspect of an embodiment of the present invention smell and taste substantially like regular, or non-hypoallergenic, peanuts. Accordingly, the hypoallergenic peanuts produced in accordance with an aspect of an embodiment of present invention may be used in instances where regular peanuts are presently used.

Aspects of embodiments of the present invention will now be described in more detail with reference to the following, specific, non-limiting examples:

### EXAMPLES

### Example 1

### Effect of α-Chymotrypsin on Heat-Treated (Blanched) and Non-Heat-Treated Peanuts

In one example, the endopeptidase α-chymotrpysin was tested for its effectiveness in reducing the allergenic activity of peanut allergens in both heat-treated and non-heat-treated peanut kernels. Measurements of concentrations of the two major allergenic proteins, Ara h1 and Ara h2, were used to indicate the reduction in activity of all known peanut allergens (e.g., Ara h1 to Ara h8).

Procedure—Unroasted (raw) or roasted peanut kernels were heat-treated by being blanched in boiling water for about 5 minutes and then cooled to about room temperature. Other peanut kernels, both raw and roasted, were used without prior heat-treatment. Samples containing either blanched unroasted, blanched roasted, non-blanched unroasted, and non-blanched roasted peanut kernels were immersed in a solution containing α-chymotrypsin, wherein the enzyme concentration was 0.01%, 0.05%, 0.10% and 0.15% (w/w), respectively. The solutions containing the peanut kernels were then incubated at a temperature of about 37° C. for 1, 3, and 5 hours, respectively. The enzyme-containing peanut kernels were dried at about 65-70° C. in a preheated vacuum oven overnight. The dried kernels were then ground into flour using a high-speed blender.

Extraction of peanut protein—One gram of peanut flour from each treatment was mixed with about 20 ml of Tris HCl buffer (pH 8.3) and stirred at room temperature for about 2 hours. Mixtures were then centrifuged at about 3,000 g for about 20 minutes. The lipid layer on top of the supernatant was removed using transfer pipettes and supernatant was stored at about −20° C. for future analysis.

Determination of soluble protein in extracts—Soluble protein in each extract was determined by bicinchoninic acid (BCA) method using bovine serum albumin (BSA) as standard. Peanut protein extracts were diluted about 5-10 times with deionized water to bring the protein concentration of the test samples within the linear rage of BSA calibration curve (0-1.0 mg/ml).

Determination of Ara h1 and Ara h2—A direct ELISA method was used to determine Ara h1 and Ara h2 in peanut extracts from treated and untreated peanut kernels, using chicken anti-Ara h1 and anti-Ara h2 as the primary antibodies and peroxidase labeled anti-chicken antibody as the detection antibody. ABTS as enzyme substrate was used for spectrometric detection of allergens. Purified Ara h1 and Ara h2 (provided by Dr. Melaki, USDA-ARS) were used as positive controls and in developing standard curves used in quantitation. Final results were calculated as mg Ara h1 and mg Ara h2 per gram of soluble protein.

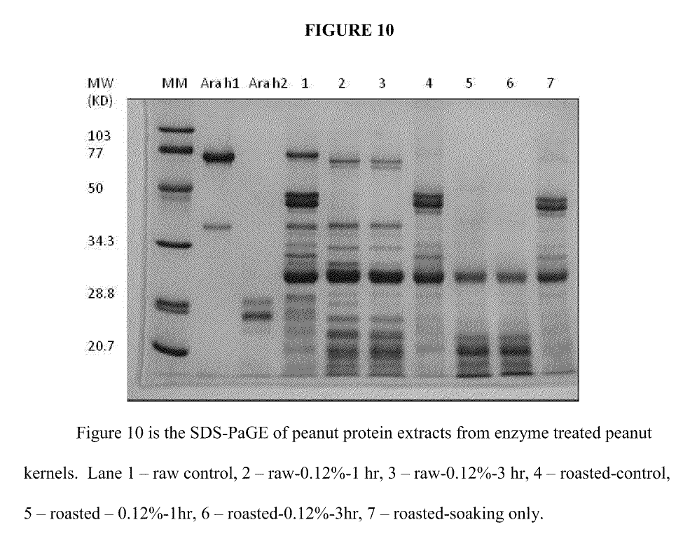

SDS-PAGE—Sodium dodecyl sulfate polyacrimide gel electrophroesis (SDS-PAGE) was used as a confirmation method for the breakdown of allergens or absence of allergenic concentrations. Depending on the protein concentration of each peanut protein extract, as determined by BCA method, extracts were diluted quantitatively to a protein concentration of about 1.0 mg/ml with SDS-PAGE buffer, then boiled at about 90° C. for about 10 minutes to completely denature the proteins. After cooling to room temperature, samples were loaded on a polyacrylamide gel (10 μl/well). The gel was then resolved using a Bio-Rad Mini-Protein gel electrophoresis system. Following staining, bands were identified using molecular weight markers and purified Ara h1 and Ara h2. (See FIG. 10.)

Results—Preliminary results showed that α-chymotrypsin demonstrated significant activity with respect to Ara h1 and Ara h2 inactivation.

TABLE 1
Changes in soluble protein of peanut kernels
after treatment with α-chymotrypsin

Treatment

| | |
|---|---|
| Enzyme | Soluble protein (mg/ml) |

| Concentration | Time | Raw | Roasted |
|---|---|---|---|
| Control (0%) | 0 | 7.029 ± 0.016 | 2.30 ± 0.02 |
| 0.010% | 1 | 4.484 ± 0.100 | 2.58 ± 0.01 |
| | 3 | 4.476 ± 0.065 | 2.79 ± 0.02 |
| | 5 | 5.079 ± 0.020 | 2.74 ± 0.05 |
| 0.050% | 1 | 5.049 ± 0.079 | 3.96 ± 0.10 |
| | 3 | 4.921 ± 0.041 | 4.20 ± 0.00 |
| | 5 | 4.768 ± 0.002 | 3.86 ± 0.01 |
| 0.100% | 1 | 5.254 ± 0.061 | 4.14 ± 0.03 |
| | 3 | 5.272 ± 0.124 | 4.12 ± 0.05 |
| | 5 | 5.150 ± 0.116 | 4.03 ± 0.02 |
| 0.150% | 1 | 6.13 ± 0.00 | 4.91 ± 0.09 |
| | 3 | 6.34 ± 0.00 | 4.56 ± 0.01 |
| | 5 | 6.41 ± 0.09 | 4.85 ± 0.00 |

Table 1 shows that, after treatment of raw peanut kernels with a solution containing α-chymotrypsin, and subsequent drying, soluble protein decreased compared to untreated samples. However, comparison of the protein concentrations of all extracts from α-chymotrypsin-treated raw peanut kernels revealed that soluble protein actually increased with increasing enzyme concentration. Even at low concentrations of α-chymotrypsin (about 0.01%), soluble protein concentration increased with treatment time. Therefore, treatment with α-chymotrypsin was effective in increasing protein solubility of peanuts. Without wishing to be bound to a particular theory, the effectiveness was probably due to proteolytic breakdown of the proteins in the peanuts into smaller, more soluble proteins.

Moreover, the lower protein concentrations in extracts from raw peanut kernels treated with low concentrations of α-chymotrypsin solution could be attributed to the drying step following enzyme treatment. Such a step could have partially denatured the native proteins in the raw peanuts. The same heat effect is also believed to be responsible for the low protein solubility in untreated (control) roasted peanuts compared to raw peanuts. However, enzyme treatment significantly increased soluble protein concentration in roasted peanut kernels for all treated samples, with higher concentrations of α-chymotrypsin yielding higher soluble proteins in the kernels. Overall, the effect of treatment time on soluble protein concentration was less significant than that of enzyme concentration. Based on SDS-PAGE results, the increased protein solubility in peanut kernels treated with solutions of α-chymotrypsin seems to correspond to the disappearance of allergen bands and increased intensities of low molecular weight protein bands in the gels of treated peanuts.

Effects of Treatment by α-Chymotrypsin on Non-Blanched Raw and Roasted Peanut Kernels

TABLE 2
Allergen changes in non-blanched raw peanut kernels
after treatment with α-chymotrypsin

| Enzyme | | | Ara h1 | Ara h2 | % | % |
|---|---|---|---|---|---|---|
| Concen- | Time | Protein | (mg/g | (mg/g | Ara h1 | Ara h2 |
| tration | hr | (mg/ml) | protein) | protein) | change | change |
| 0.01% | 1 | 7.02 | 3.60 ± 0.14 | 0.51 ± 0.04 | −4 | −48 |
| | 3 | 6.28 | 4.09 ± 0.18 | 0.59 ± 0.06 | +9 | −40 |
| | 5 | 6.05 | 3.97 ± 0.16 | 0.49 ± 0.07 | +6 | −50 |
| 0.05% | 1 | 6.99 | 2.96 ± 0.18 | 0.28 ± 0.03 | −21 | −71 |
| | 3 | 6.80 | 3.03 ± 0.29 | 0.27 ± 0.04 | −19 | −72 |
| | 5 | 6.34 | 3.20 ± 0.21 | 0.25 ± 0.02 | −15 | −75 |
| 0.10% | 1 | 6.82 | 2.82 ± 0.23 | 0.26 ± 0.06 | −25 | −73 |
| | 3 | 6.70 | 3.03 ± 0.28 | 0.25 ± 0.07 | −19 | −74 |
| | 5 | 6.33 | 3.10 ± 0.18 | 0.23 ± 0.07 | −17 | −77 |
| 0.15% | 1 | 6.49 | 2.85 ± 0.27 | 0.23 ± 0.03 | −24 | −77 |
| | 3 | 6.80 | 2.32 ± 0.18 | 0.17 ± 0.02 | −38 | −83 |
| | 5 | 6.41 | 3.25 ± 0.18 | 0.23 ± 0.02 | −13 | −76 |

Table 2 illustrates the effects of treatment of non-blanched raw peanut kernels by α-chymotrypsin on Ara h1 and Ara h2 concentrations. Data suggest that Ara h1 in non-blanched raw peanut kernels was more resistant to α-chymotrypsin activity than Ara h2. The treatment of non-blanched raw peanut kernels by low concentrations (about 0.01%) α-chymotrypsin solutions did not lower the concentration of Ara h1, but instead seemed to increase it slightly, possibly due to partial denaturation from the heat of drying of the non-blanched raw peanut kernels after enzyme treatment. Treated kernels were dried at a temperature of about 70° C. in order to inactivate the enzyme. Without wishing to be bound to a particular theory, this heat may have exposed more antibody binding sites while the α-chymotrypsin concentration was too low to make a difference.

Ara h2 in non-blanched raw peanut kernels exhibited more sensitivity to α-chymotrypsin. At an enzyme concentration of about 0.01% there was about a 40-50% reduction of Ara h2 in non-blanched raw peanuts, but when the enzyme concentration increased to about 0.05%, the reduction of Ara h2 increased to about 71-75%.

TABLE 3
Allergen changes in non-blanched roasted peanut kernels
after α-chymotrypsin treatment

| Enzyme | | | Ara h1 | Ara h2 | % | % |
|---|---|---|---|---|---|---|
| Concen- | Time | Protein | (mg/g | (mg/g | Ara h1 | Ara h2 |
| tration | hr | (mg/ml) | protein) | protein) | change | change |
| 0.01% | 1 | 4.10 | 0.91 ± 0.03 | 0.47 ± 0.03 | −63 | −39 |
| | 3 | 4.05 | 0.52 ± 0.02 | 0.33 ± 0.02 | −79 | −57 |
| | 5 | 4.21 | 0.41 ± 0.03 | 0.27 ± 0.01 | −83 | −65 |
| 0.05% | 1 | 3.49 | 0.26 ± 0.04 | 0.29 ± 0.07 | −90 | −63 |
| | 3 | 3.62 | 0.13 ± 0.01 | 0.23 ± 0.01 | −95 | −70 |
| | 5 | 3.53 | 0.22 ± 0.02 | 0.19 ± 0.01 | −91 | −76 |
| 0.10% | 1 | 3.79 | 0.19 ± 0.02 | 0.11 ± 0.01 | −92 | −86 |
| | 3 | 4.07 | 0.12 ± 0.03 | 0.12 ± 0.01 | −95 | −85 |
| | 5 | 3.79 | 0.14 ± 0.01 | 0.09 ± 0.00 | −94 | −89 |
| 0.15% | 1 | 3.91 | 0.14 ± 0.03 | 0.12 ± 0.02 | −94 | −85 |
| | 3 | 3.70 | 0.12 ± 0.02 | 0.12 ± 0.00 | −95 | −85 |
| | 5 | 4.07 | 0.23 ± 0.05 | 0.11 ± 0.05 | −91 | −86 |

Table 3 shows the effect of treatment of non-blanched roasted peanut kernels by α-chymotrypsin. The results demonstrated that the activities of both Ara h1 and Ara h2 were affected by α-chymotrypsin. At equal treatment times, higher concentrations of α-chymotrypsin resulted in higher reductions of both Ara h1 and Ara h2, while at equal enzyme concentration, longer treatment time resulted in higher reduction of both allergens.

Effects of Treatment by α-Chymotrypsin on Blanched Raw and Roasted Peanut Kernels

Both raw and roasted peanut kernels were blanched in boiling water for about 5 minutes before treatment with α-chymotrypsin. Without wishing to be bound by any particular theory, it is believed that blanching inactivates microorganisms on the surface of the peanut kernels and loosens the structure of the kernels in order to facilitate the rapid penetration of the peanut kernel by the enzyme and to increase its effectiveness.

TABLE 4
Allergen changes in blanched raw peanut kernels
after α-chymotrypsin treatment

| Enzyme | | | Ara h1 | Ara h2 | % | % |
|---|---|---|---|---|---|---|
| Concen- | Time | Protein | (mg/g | (mg/g | Ara h1 | Ara h2 |
| tration | hr | (mg/ml) | protein) | protein) | change | change |
| 0.01% | 1 | 4.48 | 5.58 ± 0.11 | 3.01 ± 0.13 | +62 | +207 |
| | 3 | 4.75 | 5.70 ± 0.29 | 2.65 ± 0.16 | +66 | +171 |
| | 5 | 5.08 | 4.97 ± 0.29 | 2.18 ± 0.24 | +44 | +122 |
| 0.05% | 1 | 5.05 | 3.97 ± 0.27 | 1.75 ± 0.16 | +15 | +79 |
| | 3 | 4.92 | 4.66 ± 0.57 | 1.93 ± 0.05 | +35 | +97 |
| | 5 | 4.77 | 4.31 ± 0.20 | 2.01 ± 0.06 | +25 | +105 |
| 0.10% | 1 | 5.25 | 3.03 ± 0.31 | 1.03 ± 0.02 | −12 | +5 |
| | 3 | 5.27 | 3.29 ± 0.20 | 1.31 ± 0.06 | −5 | +34 |
| | 5 | 5.15 | 2.74 ± 0.14 | 1.20 ± 0.03 | −21 | −23 |
| 0.15% | 1 | 6.13 | 1.99 ± 0.14 | 0.51 ± 0.01 | −42 | −48 |
| | 3 | 6.34 | 2.04 ± 0.16 | 0.62 ± 0.04 | −41 | −37 |
| | 5 | 6.41 | 2.31 ± 0.13 | 0.60 ± 0.08 | −33 | −39 |

Table 4 shows that when the concentration of α-chymotrypsin was in the range of about 0.01 to 0.05%, the treatment of blanched raw peanut kernels resulted in higher concentrations of Ara h1 and Ara h2. When the concentration of α-chymotrypsin increased to 0.10%, the concentration of Ara h1 decreased, but the concentration of Ara h2 increased. Significant reduction in the concentration of Ara h2 was achieved only when the concentration of α-chymotrypsin increased to about 0.15% and with longer incubation time.

TABLE 5
Allergen change in blanched roasted peanut kernels
after α-chymotrypsin treatment

| Enzyme | | | Ara h1 | Ara h2 | % | % |
|---|---|---|---|---|---|---|
| Concen- | Time | Protein | (mg/g | (mg/g | Ara h1 | Ara h2 |
| tration | hr | (mg/ml) | protein) | protein) | change | change |
| 0.01% | 1 | 2.58 | 0.41 ± 0.01 | 0.28 ± 0.09 | −90 | −81 |
| | 3 | 2.79 | 0.57 ± 0.08 | 0.26 ± 0.05 | −86 | −83 |
| | 5 | 2.74 | 1.23 ± 0.15 | 0.30 ± 0.06 | −68.75 | −79.83 |
| 0.05% | 1 | 3.96 | 0.25 ± 0.06 | 0.05 ± 0.04 | −94 | −98 |
| | 3 | 4.20 | 0.08 ± 0.06 | 0.03 ± 0.02 | −98 | −98 |
| | 5 | 3.86 | 0.09 ± 0.04 | 0.01 ± 0.01 | −98 | −100 |
| 0.10% | 1 | 4.14 | 0.07 ± 0.04 | 0.00 ± 0.00 | −98 | −100 |
| | 3 | 4.12 | 0.02 ± 0.03 | 0.00 ± 0.02 | −100 | −100 |
| | 5 | 4.03 | 0.00 ± 0.00 | 0.00 ± 0.00 | −100 | −100 |
| 0.15% | 1 | 4.91 | 0.00 ± 0.00 | 0.00 ± 0.00 | −100.00 | −100.00 |
| | 3 | 4.56 | 0.00 ± 0.00 | 0.00 ± 0.00 | −100.00 | −100.00 |
| | 5 | 4.85 | 0.00 ± 0.00 | 0.00 ± 0.00 | −100.00 | −100.00 |

Table 5 shows that prior blanching of light-roasted peanut kernels significantly enhanced the effectiveness of α-chymotrypsin in inactivating Ara h1 and Ara h2. Data show that, regardless of time, higher enzyme concentrations yielded higher reduction in Ara h1 and Ara h2 concentrations, and thus lower allergenic activity of peanuts. Specifically, at a concentration of α-chymotrypsin of about 0.15%, all detectable Ara h1 and Ara h2 were eliminated from roasted peanut kernels, regardless of treatment time. Thus, shorter treatment time of less than 1 hour can be used to completely inactivate peanut allergens at enzyme concentrations as low as about 0.15%.

### Example 2

### Enzyme Treatments

Samples of both raw and roasted peanut kernels (purchased from Good Earth Peanut Co., Skippers, Va.) were weighed in 25 g portions and placed in separate 250 ml flasks. These kernel samples were then blanched in boiling water for about 5 minutes. They were then drained and cooled to room temperature. Afterwards, each 25 g kernel sample was transferred to its own individual flask. Fifty milliliters of a control solution, consisting of distilled water was prepared. Fifty milliliters of enzyme solution containing 0.001, 0.01, 0.1, 0.2, 0.3, 0.4, and 0.5% of α-chymotrypsin, trypsin or a 1:1 mixture of α-chymotrypsin and trypsin (purchased from Sigma-Aldrich, St. Louis, Mo.) were added to individual flasks containing 25 g blanched and drained peanut kernels. The flasks containing the peanut kernels and enzyme solutions were capped and incubated at about 37° C. for about 3 hours. After incubation, the kernel samples were dried at about 65-70° C. in a preheated vacuum oven overnight to remove excess water and to inactivate the enzymes. The dried kernels were then ground into flour using a high-speed blender. Dried flour samples were labeled and stored at about 4° C. until used.

Treatment of peanut kernels with pepsin was conducted at a pH of about 3.0 using a citric buffer, because pepsin would lose its activity at a pH of about 6.0 or higher. Pepsin concentrations tested were 0.001, 0.002, 0.004, 0.005, 0.01, 0.05, and 0.1%. Trypsin and pepsin were both purchased from Sigma-Aldrich of St. Louis, Mo.

Extraction of peanut protein: One gram of peanut flour from each sample was mixed with 20 ml of Tris-HCl buffer (pH 8.3) and stirred at room temperature for about 2 hours. Mixtures were then centrifuged at about 3000 g for about 20 minutes. The lipid layer on the top of the supernatant was removed using transfer pipettes. Excess supernatant was stored at about −20° C. for further analysis.

Determination of soluble protein in extracts: The amount of soluble protein in each lipid extract was determined by the bicinchoninic acid (BCA) method using bovine serum albumin (BSA) as the standard. The peanut protein extracts were diluted about 5-10 times with deionized water to bring the protein concentration of the test samples within the linear range of the BSA calibration curve (0-1.0 mg/ml).

Determination of Ara h1 and Ara h2: A direct Enzyme-Linked Immunosorbent Assay (ELISA) method was used to determine Ara h1 and Ara h2 in peanut extracts from treated and untreated peanut kernels, using chicken anti-Ara h1 and anti-Ara h2 as primary antibodies, and peroxidase labeled anti-chicken antibody as the detection antibody. In order to make the spectrometric detection of the allergens Ara h1 and Ara h2, 2,2′-azino-bis(3-ethylbenzthiazoline-6-sulphonic acid) (ABTS) was used as the enzyme substrate. Purified Ara h1 and Ara h2 (provided by Dr. Melaki, USDA-ARS) were used as positive controls and in developing standard curves used in quantitation. Final results were calculated as mg Ara h1/g soluble protein or mg Ara h2/g soluble protein.

SDS-PAGE: Depending on the protein concentration of each peanut extract, as determined by the BCA method, extracts were diluted quantitatively to a protein concentration of about 1.0 mg/ml with SDS-PAGE buffer, then boiled at about 90° C. for about 10 minutes to completely denature the proteins. After cooling to room temperature, samples were loaded on a polyacrylamide gel (100 μl/well). Following staining, bands were identified using molecular weight markers and purified Ara h1 and Ara h2.

Results: Table 6 shows that the soluble protein of the peanut kernels treated with α-chymotrypsin increased as compared to the untreated kernels. The soluble protein concentrations of all extracts from the α-chymotrypsin-treated peanut kernels increased with increasing enzyme concentration. The protein soluble concentrations of all extracts from the α-chymotrypsin-treated peanut kernels reveals that soluble protein levels actually increased with increasing enzyme concentration. Even the lowest enzyme concentration used (0.001%) showed a slight increase in the soluble protein over the untreated control. This demonstrated that the treatment of the peanut kernels with α-chymotrypsin was effective in increasing the protein solubility of the peanut kernels, probably through proteolytic breakdown into smaller more soluble proteins. Similar results were observed for trypsin and the mixture of trypsin and α-chymotrypsin (1:1) (Table 6).

TABLE 6
Effect of enzyme type and concentration on reduction of
Ara h1 and Ara h2 in roasted peanut kernels (incubation
time about 3 hours at about 37° C.)

| | | Soluble | Ara h1 | | Ara h2 | |
|---|---|---|---|---|---|---|
| Enzyme | Enzyme | protein | (mg/g | % Ara | (mg/g | % Ara |
| type | (%) | (mg/ml) | protein) | reduction | protein) | reduction |
| Control | 0 | 2.31 | 8.28 | — | 1.95 | — |
| α-chymo- | 0.5 | 5.41 | 0.00 | 100.00 | 0.00 | 100.00 |
| trypsin | | | | | | |
| | 0.4 | 5.49 | 0.05 | 95.76 | 0.1 | 96 |
| | 0.3 | 4.58 | 0.00 | 100.00 | 0 | 100 |
| | 0.2 | 4.71 | 0.05 | 97.77 | 0 | 98 |
| | 0.1 | 4.29 | 0.23 | 97.19 | 0.2 | 92 |
| | 0.01 | 3.16 | 1.00 | 87.92 | 0.4 | 78 |
| | 0.001 | 2.39 | 2.63 | 68.26 | 1 | 50 |
| trypsin | 0.5 | 5.74 | 0.00 | 99.28 | 0 | 100 |
| | 0.4 | 5.58 | 0.00 | 100.00 | 0 | 100 |
| | 0.3 | 5.50 | 0.00 | 100.00 | 0 | 100 |
| | 0.2 | 3.92 | 0.00 | 100.00 | 0 | 100 |
| | 0.1 | 6.55 | 0.00 | 100.00 | 0 | 100 |
| | 0.01 | 4.34 | 0.34 | 95.88 | 0.3 | 86 |
| | 0.001 | 2.13 | 2.92 | 64.69 | 1 | 57 |
| α-chymo- | 0.5 | 6.40 | 0 | 100 | 0 | 100 |
| trypsin + | | | | | | |
| trypsin | | | | | | |
| | 0.4 | 6.54 | 0 | 99.61 | 0.01 | 99.61 |
| | 0.3 | 6.49 | 0.03 | 98.37 | 0.03 | 98.37 |
| | 0.2 | 6.24 | 0 | 100 | 0 | 100.00 |
| | 0.1 | 6.38 | 0 | 100 | 0 | 100 |
| | 0.01 | 4.57 | 0.48 | 94.19 | 0.35 | 82.29 |
| | 0.001 | 3.33 | 3.96 | 52.18 | 0.86 | 55.88 |
| Pepsin | 0.001 | 2.04 | 5.02 | 39.37 | 1.03 | 47.18 |
| | 0.002 | 2.16 | 4.04 | 51.21 | 1.01 | 48.21 |
| | 0.004 | 2.12 | 3.40 | 58.94 | 0.74 | 62.05 |
| | 0.005 | 2.22 | 2.62 | 68.36 | 0.61 | 68.72 |
| | 0.01 | 1.92 | 3.18 | 61.59 | 0.71 | 63.59 |
| | 0.05 | 2.12 | 4.21 | 49.15 | 0.72 | 63.08 |
| | 0.1 | 1.94 | 3.12 | 62.32 | 0.69 | 64.62 |

Table 6 shows the effect of enzyme type and enzyme concentration on the reduction of Ara h1 and Ara h2 in roasted peanut kernels at a treatment time of about 3 hours and an incubation temperature of about 37° C. It was observed that the use of solutions containing about 0.2% (w/w) and higher α-chymotrypsin resulted in the substantially complete inactivation of both Ara h1 and Ara h2. It was also observed that the use of solutions containing about 0.1% (w/w) and higher trypsin resulted in the substantially complete inactivation of both Ara h1 and Ara h2. It was also observed that the use of solutions containing about 0.1% (w/w) and higher of the mixture of α-chymotrypsin and trypsin (1:1) resulted in the substantially complete inactivation of both Ara h1 and Ara h2. It was further observed that the level of Ara h1 and Ara h2 inactivation increased linearly with enzyme concentration, but reached a maximum at enzyme concentrations between about 0.1% and about 0.2% (w/w), after which allergen inactivation leveled off and remained constant at about 100%. However, this maximum activity will depend on the experimental conditions used to treat the peanuts, and this maximum may shift upward or downward.

TABLE 7
Effects of enzyme treatment time on the reduction of
Ara h1 and Ara h2 in roasted peanut kernels at a total
enzyme concentration of about 0.15% (w/w) and incubation
temperature of about 37° C.

| | Enzyme | Soluble | Ara h1 | | Ara h2 | |
|---|---|---|---|---|---|---|
| Enzyme | time | protein | (mg/g | % Ara h1 | (mg/g | % Ara h2 |
| type | (hr) | (mg/ml) | protein) | reduction | protein) | reduction |
| Control | 0 | 2.69 | 6.87 | — | 1.27 | — |
| α-chymo- | 0.25 | 6.53 | 0.00 | 100.00 | 0 | 100 |
| trypsin | | | | | | |
| | 0.5 | 6.23 | 0.03 | 99.52 | 0 | 100 |
| | 1.0 | 5.96 | 0.00 | 100.00 | 0 | 100 |
| | 2.0 | 6.54 | 0.00 | 100.00 | 0 | 100 |
| | 3.0 | 6.43 | 0.00 | 100.00 | 0 | 100 |
| | 4.0 | 6.65 | 0.00 | 100.00 | 0 | 100 |
| | 5.0 | 6.27 | 0.00 | 100.00 | 0 | 100 |
| | 6.0 | 6.80 | 0.00 | 100.00 | 0 | 100 |
| | 7.0 | 6.23 | 0.00 | 100.00 | 0 | 100 |
| | 8.0 | 5.78 | 0.00 | 100.00 | 0 | 100 |
| trypsin | 0.25 | 7.28 | 0.00 | 100.00 | 0 | 98 |
| | 0.5 | 7.28 | 0.00 | 100.00 | 0 | 100 |
| | 1.0 | 7.33 | 0.00 | 100.00 | 0 | 100 |
| | 2.0 | 7.37 | 0.00 | 100.00 | 0 | 100 |
| | 3.0 | 7.31 | 0.00 | 100.00 | 0 | 99 |
| | 4.0 | 7.14 | 0.00 | 100.00 | 0 | 98 |
| | 5.0 | 7.22 | 0.00 | 100.00 | 0 | 100 |
| | 6.0 | 6.85 | 0.00 | 100.00 | 0 | 98 |
| | 7.0 | 6.98 | 0.00 | 100.00 | 0 | 99 |
| | 8.0 | 7.46 | 0.00 | 100.00 | 0 | 96 |

Table 7 shows the effects of enzyme treatment time on the reduction of Ara h1 and Ara h2 in roasted peanut kernels at a total enzyme concentration of about 0.15% (w/w) and an incubation temperature of about 37° C. Two 0.15% (w/w) enzyme solutions were utilized: a solution containing α-chymotrypsin alone, and a solution containing trypsin alone. Total treatment time with each of the two enzyme solutions was up to 8 hours, with measurements of soluble protein (mg/ml), Ara h1 (mg/g) and Ara h2 (mg/g) taken at intervals of 15 minutes, 30 minutes, 1 hour, and hourly thereafter up to and including 8 hours. It was observed that the enzyme action on Ara h1 and Ara h2 was extremely fast, resulting in the near elimination of these two allergens within about 15 minutes (0.25 hrs). The efficiency of the enzymatic reaction continued to increase with time for up to about one hour, after which enzyme activity remained constant or leveled off slightly.

While the present invention has been described in connection with the above-identified embodiments, it is to be understood that other similar embodiments may be used or modifications and additions may be made to the described embodiments for performing the same function of the present invention without deviating therefrom. Therefore, the present invention should not be limited to any single embodiment, but rather construed in breadth and scope in accordance with the recitation of the appended claims.

### Example 3

### Production of Hypoallergenic Peanut Butter

### Effect of α-Chymotrypsin and Trypsin on Allergens of Home-Made and Commercially Available Peanut Butters

In one example, the endopeptidases α-chymotrypsin and trypsin were tested for their individual and conjunctive effectiveness in reducing the allergenic activity of peanut allergens in both home-made and commercially available peanut butters.

Procedure—A solution containing α-chymotrypsin, (Catalogue No.: C-4129, available from Sigma Aldrich), trypsin, (Catalogue No.: T369-500, available from Fisher Scientific), or a combination of both was introduced to home-made or commercially available peanut butter. One set of solutions was a 2.5 ml solution which contained 2, 4, 6, 8, 10, and 12 mg of enzyme per milliliter, respectively. A second solution was of a 1:1 ratio of α-chymotrypsin and trypsin. A third solution was a 1.25 ml solution which contained 20 mg of enzyme. A fourth solution was a 5 ml solution which contained 20 mg of enzyme.

The home-made peanut butter samples were prepared by grinding 50 g of roasted peanuts for 30 seconds using a home peanut butter maker (Miracle Mincer Model No.: TR30, available from Miracle Exclusives), followed by the addition of 15 ml of vegetable oil (available from any grocery store). The mixture was then ground for another about 20 seconds using the Miracle Mincer TR30.

The commercial peanut butter samples were individual 100 g samples of Jif® Reduced Fat Creamy, Jif® Creamy, Skippy® Reduced Fat Creamy, Skippy® Creamy, and Market Pantry® Creamy Peanut Butter. The commercial peanut butter samples were obtained from Target® but may also be found in various supermarkets.

The home-made peanut butter mixture was mixed using the Miracle Mincer TR30 for another about 20-30 seconds following addition of the appropriate enzyme solution yielding enzyme to peanut ratios from about 0.01 to about 0.06%.

The commercial peanut butter samples were mixed using the Miracle Mincer TR30 for 30 seconds following addition of 2.5 ml of enzyme solution containing α-chymotrypsin and trypsin at 1:1 ratio, yielding enzyme to peanut ratio of 0.06%.

Treated peanut butter samples and control were transferred to pre-sterile plastic containers and left to incubate at room temperature (22° C.) for 24 hours or at 37° C. for 2 hours before determination of soluble proteins and allergens (Ara h1 and Ara h2). Samples were then refrigerated at 4° C. and tested weekly for soluble protein and allergens. During each sampling, 1 g of the home-made peanut butter, 1.05 g of the enzyme treated commercial peanut, and 1 g of the untreated commercial peanut butter was taken from each respective peanut butter sample for protein and allergen determination.

Extraction of peanut protein—One gram (1.00±0.01) of peanut butter (from treated and untreated home-made and commercially available peanut butters) was mixed with 20 ml of Tris-HCl buffer (pH 8.3) and stirred on a Horizon stirrer (Brinkmann Instruments, available from Fisher Scientific) at room temperature for 1 hr. Mixtures were then centrifuged at 3000 g for 20 min. The lipid layer on the top of supernatant was removed using transfer pipettes and supernatant was stored at −20° C. for further analysis.

Determination of soluble protein in extracts—Soluble proteins in each extract were determined by BCA method using BSA as standard. BCA kit was purchased from PIERCE (Rockford, Ill.). Peanut protein extracts were diluted 5-10 times using deionized water to bring protein concentration of test samples within the linear range of the BCA calibration curve (0-1.0 mg/ml). Protein concentration in peanut extract was expressed as mg protein/ml extract.

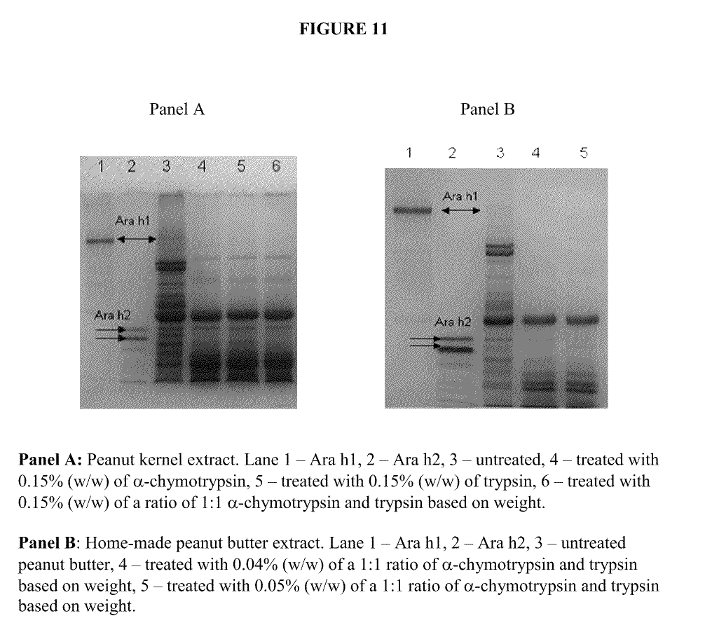

SDS-PAGE—Protein/peptide profile of peanut protein before and after treatment was resolved by SDS-PAGE using a Bio-Rad Mini Protein III system (Bio-Rad, Hercules, Calif.) with 12% acrylamide gel (15×10 cm). Molecular markers with molecular weights of 103, 77, 50, 34.3, 28.8 and 20.7 KD were used as reference. Extracts were mixed with 2× sample treatment buffer (pH 6.8) to a total protein concentration of 1.00 mg/ml before boiling at 90° C. for 10 minutes to completely denature the protein. After cooling to room temperature, samples were loaded onto the gel (5 ml/well). Purified peanut allergens Ara h1 and Ara h2 were used as references. The gel was resolved at power conditions recommended by Bio-Rad (200V, 120 mA and 45 min), then stained with Coomassie brilliant blue R-250 solution (Bio-Rad) for 4-5 hours or overnight. After destaining, the gel images were obtained using a Gel Doc XR imaging system (Bio-Rad, Hercules, Calif.). (See FIG. 11.)

Determination of Ara h1 and Ara h2—Ara h1 and Ara h2 in crude peanut protein extracts were determined by a direct ELISA. Peanut protein extracts were ⅕- 1/10 diluted using PBS (pH 7.4) prior to use in ELISA assays. The latter involved the use of chicken anti-Ara h1 and anti-Ara h2 antibodies as primary antibodies and peroxidase labeled anti-chicken antibodies as detection antibodies. Purified Ara h1 and Ara h2 were used as positive controls. The final results were calculated as mg Ara h1 or Ara h2/g soluble protein.

Results—In the following results, α-chymotrypsin is designated E1 and trypsin is designated E2. Table 8 shows that after 24 hours of enzymatic reaction at room temperature, 22° C., the concentration of major peanut allergens Ara h1 and Ara h2 in the home-made peanut butter samples decreased significantly. Higher reductions of Ara h1 and Ara h2 were observed in peanut butter samples treated with the enzyme mixture. Graphs 1, 2 and 3 chart the concentrations of Ara h1 and Ara h2 in home-made peanut butter when treated with α-chymotrypsin, trypsin and a combination of both enzymes as shown in Table 8.

TABLE 8
Effect of enzyme concentration on allergens in
home-made peanut butter following 24 hr incubation
at room temperature (22° C.).

| Type | Enzyme | Soluble | Ara h1 | Ara h2 | | |
|---|---|---|---|---|---|---|
| of | Concen- | Protein | (mg/g | (mg/g | % Ara h1 | % Ara h2 |
| enzyme | tration | (mg/ml) | protein) | protein) | Reduction | Reduction |
| Control | 0.00% | 3.08 | 3.27 | 1.25 | 0.0 | 0.0 |
| E1 | 0.01% | 3.84 | 0.72 | 0.45 | 81.9 | 64.0 |
| | 0.02% | 3.95 | 0.40 | 0.23 | 89.9 | 80.8 |
| | 0.03% | 4.15 | 0.26 | 0.21 | 93.4 | 87.8 |
| | 0.04% | 5.36 | 0.16 | 0.19 | 92.9 | 81.9 |
| | 0.05% | 5.24 | 0.15 | 0.15 | 93.7 | 86.1 |
| | 0.06% | 5.39 | 0.08 | 0.13 | 96.4 | 87.5 |
| E2 | 0.00% | 3.08 | 3.27 | 1.25 | 0.0 | 0.0 |
| | 0.01% | 4.78 | 0.29 | 0.24 | 92.3 | 81.5 |
| | 0.02% | 4.80 | 0.05 | 0.10 | 98.6 | 92.3 |
| | 0.03% | 4.16 | 0.04 | 0.11 | 99.1 | 91.5 |
| | 0.04% | 5.32 | 0.00 | 0.02 | 100.0 | 98.4 |
| | 0.05% | 5.89 | 0.00 | 0.03 | 100.0 | 97.3 |
| | 0.06% | 5.74 | 0.00 | 0.01 | 100.0 | 99.4 |
| E1 + E2 | 0.00% | 3.08 | 3.27 | 1.25 | 0.0 | 0.0 |
| | 0.01% | 4.18 | 0.27 | 0.15 | 93.2 | 83.4 |
| | 0.02% | 4.40 | 0.08 | 0.11 | 98.1 | 91.6 |
| | 0.03% | 4.82 | 0.00 | 0.06 | 100 | 95.0 |
| | 0.04% | 5.42 | 0.00 | 0.01 | 100 | 99.2 |
| | 0.05% | 5.76 | 0.00 | 0.01 | 100 | 98.7 |
| | 0.06% | 6.10 | 0.00 | 0.01 | 100 | 99.4 |

Tables 9 and 10 show that refrigeration storage (4° C.) of enzymatically treated home-made peanut butter for 1-2 weeks following the initial 24 hour room temperature (22° C.) incubation did not result in a significant change in the levels of detectable Ara h1 or Ara h2.

TABLE 9
Effect of enzyme concentration on allergens in
home-made peanut butter following one week
of storage at 4° C.

| Type | Enzyme | Soluble | Ara h1 | Ara h2 | | |
|---|---|---|---|---|---|---|
| of | Concen- | Protein | (mg/g | (mg/g | % Ara h1 | % Ara h2 |
| enzyme | tration | (mg/ml) | protein) | protein) | Reduction | Reduction |
| Control | 0.00% | 3.03 | 2.77 | 1.16 | 0 | 0 |
| E1 | 0.01% | 3.83 | 0.46 | 0.41 | 83.3 | 65.2 |
| | 0.02% | 4.31 | 0.22 | 0.20 | 92.0 | 83.1 |
| | 0.03% | 4.11 | 0.14 | 0.14 | 94.8 | 87.8 |
| | 0.04% | 4.80 | 0.11 | 0.13 | 95.4 | 90.6 |
| E2 | 0.01% | 4.77 | 0.29 | 0.26 | 92.7 | 83.4 |
| | 0.02% | 4.79 | 0.05 | 0.11 | 98.6 | 92.7 |
| | 0.03% | 4.16 | 0.04 | 0.11 | 99.1 | 92.7 |
| | 0.04% | 5.08 | 0.01 | 0.05 | 99.7 | 94.8 |
| E1 + E2 | 0.01% | 4.18 | 0.27 | 0.24 | 93.2 | 84.6 |
| | 0.02% | 4.40 | 0.08 | 0.09 | 98.1 | 94.0 |
| | 0.03% | 4.82 | 0.00 | 0.07 | 100.0 | 95.7 |
| | 0.04% | 5.42 | 0.00 | 0.04 | 100.0 | 95.6 |

TABLE 10
Effect of enzyme concentration on allergens in
home-made peanut butter following two weeks
of storage at 4° C.

| Type | Enzyme | Soluble | Ara h1 | Ara h2 | | |
|---|---|---|---|---|---|---|
| of | Concen- | Protein | (mg/g | (mg/g | % Ara h1 | % Ara h2 |
| enzyme | tration | (mg/ml) | protein) | protein) | Reduction | Reduction |
| Control | 0.00% | 3.32 | 3.37 | 1.35 | 0 | 0.00 |
| E1 | 0.01% | 4.29 | 0.85 | 0.53 | 74.8 | 60.6 |
| | 0.02% | 4.50 | 0.36 | 0.26 | 98.2 | 80.6 |
| | 0.03% | 4.50 | 0.26 | 0.17 | 92.4 | 87.2 |
| | 0.04% | 4.80 | 0.09 | 0.14 | 96.8 | 87.3 |
| E2 | 0.01% | 4.98 | 0.30 | 0.25 | 91.3 | 81.2 |
| | 0.02% | 5.18 | 0.05 | 0.08 | 98.6 | 94.3 |
| | 0.03% | 5.43 | 0.01 | 0.05 | 99.8 | 96.0 |
| | 0.04% | 4.94 | 0.00 | 0.04 | 100.0 | 96.1 |
| E1 + E2 | 0.01% | 4.70 | 0.23 | 0.22 | 93.2 | 84.0 |
| | 0.02% | 5.19 | 0.03 | 0.08 | 99.1 | 94.3 |
| | 0.03% | 5.03 | 0.00 | 0.02 | 100.0 | 98.3 |
| | 0.04% | 4.87 | 0.00 | 0.02 | 100.0 | 98.0 |

Table 11 shows that after 24 hours of enzymatic reaction at room temperature (22° C.), the concentration of major peanut allergens Ara h1 and Ara h2 in commercially available peanut butters decreased significantly and then remained almost unchanged following refrigeration storage (4° C.) for 1 week. Graph 4 charts the detectable Ara h1 levels in commercially available peanut butters following enzymatic treatment at 22° C. for 24 hours as shown in Table 11. Graph 5 charts the detectable Ara h2 levels in commercially available peanut butters following enzymatic treatment at 22° C. for 24 hours as shown in Table 11. Graph 6 compares reduction of Ara h1 and Ara h2 protein levels in commercially available peanut butters following the enzymatic treatment at 22° C. for 24 hours and enzymatic treatment at 22° C. for 24 hours followed by cold storage at 4° C. for one week as shown in Table 11.

TABLE 11
Effect of enzyme treatment on allergens in commercially available peanut butter
samples (enzyme (trypsin and α-chymotrypsin at 1:1 by weight) to
peanut butter ratio = 0.06% w/w).

| | | Peanut butter brands | | | | |
|---|---|---|---|---|---|---|
| | | | | | | Market |
| | | Jif ® | Skippy ® | Jif ® | Skippy ® | Pantry ® |
| | | low fat | low fat | regular | regular | regular |
| Control samples | Total protein | 159.34 | 109.49 | 120.99 | 104.26 | 124.38 |
| | (mg/g butter) | | | | | |
| | Ara h1 | 21.79 | 33.30 | 29.88 | 32.47 | 28.22 |
| | (mg/g | | | | | |
| | protein) | | | | | |
| | Ara h2 (mg/g | 15.80 | 31.04 | 21.88 | 32.66 | 24.84 |
| | protein) | | | | | |
| Samples treated at | Total protein | 136.32 | 147.1 | 176.57 | 158.98 | 160.16 |
| 22° C. for 24 hr | (mg/g butter) | | | | | |
| | Ara h1 | 0.46 | 0.47 | 0.53 | 0.61 | 0.66 |
| | (mg/g | | | | | |
| | protein) | | | | | |
| | Ara h2 (mg/g | 0.16 | 0.28 | 0.18 | 0.35 | 0.35 |
| | protein) | | | | | |
| | % Ara h1 | 97.87 | 98.58 | 98.21 | 98.13 | 97.64 |
| | Reduction | | | | | |
| | % Ara h2 | 99.01 | 99.11 | 99.18 | 98.91 | 98.58 |
| | Reduction | | | | | |
| Samples treated at | Total protein | 148.46 | 116.14 | 157.77 | 196.07 | 169.8 |
| 22° C. for 24 hrs, | (mg/g butter) | | | | | |
| and stored at 4° C. | Ara h1 | 0.90 | 1.06 | 0.96 | 0.88 | 0.95 |
| for 1 week | (mg/g | | | | | |
| | protein) | | | | | |
| | Ara h2 (mg/g | 0.21 | 0.42 | 0.27 | 0.39 | 0.19 |
| | protein) | | | | | |
| | % Ara h1 | 95.88 | 96.81 | 96.78 | 97.28 | 96.64 |
| | Reduction | | | | | |
| | % Ara h2 | 98.69 | 98.63 | 98.77 | 98.80 | 99.23 |
| | Reduction | | | | | |

Table 12 shows that after 2 hours of enzymatic reaction at 37° C., the concentration of major peanut allergens Ara h1 and Ara h2 in commercially available peanut butters decreased significantly and then remained almost unchanged following refrigeration (4° C.) for 1 week. Graph 7 charts the detectable Ara h1 levels in commercially available peanut butters following enzymatic treatment at 37° C. for 2 hours as shown in Table 12. Graph 8 charts the detectable Ara h2 levels in commercially available peanut butters following the enzymatic treatment at 37° C. for 2 hours as shown in Table 12. Graph 9 compares reduction of Ara h1 and Ara h2 protein levels in commercially available peanut butters following the enzymatic treatment at 37° C. for 2 hours and enzymatic treatment at 37° C. for 2 hours followed by cold storage at 4° C. for one week as shown in Table 12.

TABLE 12
Effect of enzyme treatment on allergens in commercially available peanut butter
samples (enzyme (trypsin and α-chymotrypsin at 1:1 in weight) to
peanut butter ratio = 0.06% w/w).

| | | Peanut butter brands | | | | |
|---|---|---|---|---|---|---|
| | | | | | | Market |
| | | Jif ® | Skippy ® | Jif ® | Skippy ® | Pantry ® |
| | | low fat | low fat | regular | regular | regular |
| Control samples | Total protein | 159.34 | 109.49 | 120.99 | 104.26 | 124.38 |
| | (mg/g butter) | | | | | |
| | Ara h1 | 21.79 | 33.30 | 29.88 | 32.47 | 28.22 |
| | (mg/g | | | | | |
| | protein) | | | | | |
| | Ara h2 | 15.80 | 31.04 | 21.88 | 32.66 | 24.84 |
| | (mg/g | | | | | |
| | protein) | | | | | |
| Samples treated at | Total protein | 158.77 | 135 | 142.12 | 160.33 | 174.45 |
| 37° C. for 2 hrs | (mg/g butter) | | | | | |
| | Ara h1 | 0.44 | 0.50 | 0.50 | 0.56 | 0.49 |
| | (mg/g | | | | | |
| | protein) | | | | | |
| | Ara h2 | 0.18 | 0.19 | 0.16 | 0.29 | 0.23 |
| | (mg/g | | | | | |
| | protein) | | | | | |
| | % Ara h1 | 98.00 | 98.51 | 98.31 | 98.27 | 98.25 |
| | Reduction | | | | | |
| | % Ara h2 | 98.83 | 99.40 | 99.29 | 99.12 | 99.09 |
| | Reduction | | | | | |
| Samples treated at | Total protein | 152.06 | 140.85 | 162.45 | 174.27 | 202.27 |
| 37° C. for 2 hrs, | (mg/g butter) | | | | | |
| and stored at 4° C. | Ara h1 | 0.71 | 0.76 | 0.78 | 0.76 | 0.66 |
| for 1 week | (mg/g | | | | | |
| | protein) | | | | | |
| | Ara h2 (mg/g | 0.19 | 0.38 | 0.23 | 0.33 | 0.26 |
| | protein) | | | | | |
| | % Ara h1 | 96.75 | 97.72 | 97.39 | 97.66 | 97.65 |
| | Reduction | | | | | |
| | % Ara h2 | 98.77 | 98.76 | 98.96 | 98.98 | 98.96 |
| | Reduction | | | | | |

Tables 13, 14 and 15 show the effect of water volume on allergens Ara h1 and Ara h2 in home-made peanut butter samples treated with solutions of 1.25, 2.5, or 5 ml having 20 mg of enzyme. The home-made peanut butter resulting from treatment with the 5 ml of enzyme solution was coarser than those produced with 2.5 and 1.25 ml of enzyme solution. The consistency of the home-made peanut butter samples treated with 1.25 ml and 2.5 mL of enzyme solution were similar to that of the control peanut butter. The 2.5 ml volume enabled dissolution of all the enzymes (20 mg/2.5 mL) and did not adversely affect the consistency of treated, home-made peanut butter.

TABLE 13
Effect of water volume on allergens in home-made
peanut butter following incubation at room temperature
(22° C.) for 24 hrs

| Type | Water | Soluble | Ara h1 | Ara h2 | | |
|---|---|---|---|---|---|---|
| of | volume | Protein | (mg/g | (mg/g | % Ara h1 | % Ara h2 |
| enzyme | (ml) | (mg/ml) | protein) | protein) | Reduction | Reduction |
| Control | 0.00 | 3.48 | 2.36 | 1.25 | 0.0 | 0 |
| E1 | 1.25 | 4.77 | 0.11 | 0.13 | 95.4 | 83.6 |
| | 2.50 | 4.92 | 0.13 | 0.12 | 94.7 | 84.6 |
| | 5.00 | 4.24 | 0.10 | 0.09 | 95.6 | 88.2 |
| E2 | 1.25 | 5.46 | 0.00 | 0.03 | 100.0 | 95.6 |
| | 2.50 | 5.66 | 0.00 | 0.03 | 100.0 | 96.6 |
| | 5.00 | 5.16 | 0.00 | 0.03 | 100.0 | 96.3 |
| E1 + E2 | 1.25 | 5.42 | 0.00 | 0.03 | 100.0 | 96.5 |
| | 2.50 | 5.74 | 0.00 | 0.04 | 100.0 | 94.9 |
| | 5.00 | 5.31 | 0.00 | 0.02 | 100.0 | 97.1 |

TABLE 14
Effect of water volume on allergens in home-made
peanut butter following one week of refrigerated storage.

| Type | Water | Soluble | Ara h1 | Ara h2 | | |
|---|---|---|---|---|---|---|
| of | volume | Protein | (mg/g | (mg/g | % Ara h1 | % Ara h2 |
| enzyme | (ml) | (mg/ml) | protein) | protein) | Reduction | Reduction |
| Control | 0.00 | 3.26 | 3.02 | 1.04 | 0.0 | 0.0 |
| E1 | 1.25 | 4.63 | 0.17 | 0.18 | 94.2 | 82.3 |
| | 2.50 | 5.25 | 0.15 | 0.12 | 95.2 | 88.2 |
| | 5.00 | 4.66 | 0.17 | 0.14 | 94.3 | 86.4 |
| E2 | 1.25 | 5.26 | 0.008 | 0.05 | 99.7 | 95.3 |
| | 2.50 | 6.18 | 0.015 | 0.05 | 99.5 | 95.1 |
| | 5.00 | 5.28 | 0.014 | 0.06 | 99.6 | 93.9 |
| E1 + E2 | 1.25 | 5.28 | 0.00 | 0.04 | 100.0 | 95.7 |
| | 2.50 | 5.18 | 0.00 | 0.05 | 100.0 | 94.9 |
| | 5.00 | 5.12 | 0.00 | 0.06 | 100.0 | 94.8 |

TABLE 15
Effect of water volume on allergens in home-made
peanut butter following two weeks of refrigerated storage

| Type | Water | Soluble | Ara h1 | Ara h2 | | |
|---|---|---|---|---|---|---|
| of | volume | Protein | (mg/g | (mg/g | % Ara h1 | % Ara h2 |
| enzyme | (ml) | (mg/ml) | protein) | protein) | Reduction | Reduction |
| Control | 0.00 | 3.389 | 2.931 | 1.14 | 0.00 | 0.00 |
| E1 | 1.25 | 4.775 | 0.094 | 0.144 | 96.81 | 87.34 |
| | 2.50 | 4.405 | 0.103 | 0.131 | 96.48 | 88.48 |
| | 5.00 | 4.109 | 0.094 | 0.154 | 96.81 | 86.47 |
| E2 | 1.25 | 4.939 | 0.00 | 0.044 | 100.0 | 96.12 |
| | 2.50 | 5.163 | 0.00 | 0.038 | 100.0 | 96.67 |
| | 5.00 | 4.607 | 0.00 | 0.028 | 100.0 | 97.53 |
| E1 + E2 | 1.25 | 4.872 | 0.00 | 0.023 | 100.0 | 97.96 |
| | 2.50 | 5.145 | 0.00 | 0.034 | 100.0 | 97.03 |
| | 5.00 | 5.098 | 0.00 | 0.028 | 100.0 | 97.58 |

### CONCLUSION

Allergenicity of peanut butter can be reduced by enzyme treatment. Enzyme addition may be carried out as the last step during peanut butter processing to prevent enzyme denaturation and loss of activity due to mechanical shearing and heat from grinding friction. Degradation of Ara h1 and Ara h2 was largely completed within the 24 hr room temperature incubation or 2 hr incubation at 37° C. following addition of enzymes to peanut butter. Treated peanut butter can be pasteurized and/or refrigerated after the first 24 hr enzymatic reaction without major changes in its composition and allergen content. Treatment of peanut butter did not involve any heating or chemical additives and treated peanut butter retained its original flavor, taste and consistency.

Numerous other aspects of embodiments, embodiments, features, and advantages of the present invention will appear from the following detailed description and the accompanying drawings. In the description and/or the accompanying drawings, reference is made to exemplary aspects of embodiments and/or embodiments of the invention which can be applied individually or combined in any way with each other. Such aspects of embodiments and/or embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. Also in the interest of brevity and conciseness, it is to be understood that such terms as “is,” “are,” “includes,” “having,” “comprises,” and the like are words of convenience and are not to be construed as limiting terms and yet may encompass the terms “comprises,” “consists essentially of,” “consists of,” and the like as is appropriate.

What is claimed is:

1. A method for reducing the allergenic protein content of peanut butter, comprising contacting said peanut butter with a hypoallergenically-effective amount of at least one endopeptidase enzyme.

2. The method according to claim 1, wherein the said hypoallergenically-effective amount of the said endopeptidase enzyme is at least about 0.01% (w/w).

3. The method according to claim 1, wherein the said hypoallergenically-effective amount of at least one endopeptidase is from about 0.01% to about 0.1% (w/w).

4. The method according to claim 1, wherein the said endopeptidase is trypsin.

5. The method according to claim 1, wherein the said endopeptidase is α-chymotrypsin.

6. The method according to claim 1, wherein the said endopeptidase is a combination of trypsin and α-chymotrypsin.

7. The method according to claim 1, wherein said peanut butter is pasteurized, refrigerated, or any combination thereof after contacting said peanut butter with a hypoallergenically-effective amount of at least one endopeptidase enzyme.

8. The method according to claim 7, wherein said peanut butter is pasteurized, refrigerated, or any combination thereof 2 hours or more after contacting said peanut butter with a hypoallergenically-effective amount of at least one endopeptidase enzyme.

9. The method according to claim 1, further comprising contacting said peanut butter with a hypoallergenically-effective amount of at least one endopeptidase enzyme in the presence of heat.

10. The method according to claim 9, wherein said heat is about 37° C.

11. The method according to claim 1, further comprising contacting said peanut butter with a hypoallergenically-effective amount of at least one endopeptidase enzyme at about 22° C.

12. A hypoallergenic peanut product produced according to claim 1.

13. A product containing peanut butter produced according to claim 1 wherein the levels of Ara h1 are less than about 2 mg/g protein.

14. A product containing peanut butter produced according to claim 1 wherein the levels of Ara h1 are less than about 1 mg/g protein.

15. A product containing peanut butter produced according to claim 1 wherein the levels of Ara h1 are 0.00 mg/g to about 2 mg/g protein.

16. A product containing peanut butter produced according to claim 1 wherein the levels of Ara h1 are 0.00 mg/g to about 1 mg/g protein.

17. A product containing peanut butter produced according to claim 1 wherein the levels of Ara h2 are less than about 2 mg/g protein.

18. A product containing peanut butter produced according to claim 1 wherein the levels of Ara h2 are less than about 1 mg/g protein.

19. A product containing peanut butter produced according to claim 1 wherein the levels of Ara h2 are 0.00 mg/g to about 2 mg/g protein.

20. A product containing peanut butter produced according to claim 1 wherein the levels of Ara h2 are 0.00 mg/g to about 1 mg/g protein.

21. A product containing peanut butter produced according to claim 1 wherein the level of Ara h1 has been decreased by about 30% or more.

22. A product containing peanut butter produced according to claim 1 wherein the level of Ara h2 has been decreased by about 30% or more.
